(19) United States
(12) Patent Application Publication
(10) Pub. No.: US 2013/0173409 A1
(43) Pub. Date: Jul. 4, 2013

(54) Network Trading Systems and Methods

(71) Applicant: CHIDOPI CO., LTD., Taipei City (TW)

(72) Inventor: Jason Hung, Taoyuan County (TW)

(73) Assignee: CHIDOPI CO., LTD., Taipei City (TW)

(21) Appl. No.: 13/732,379

(22) Filed: Jan. 1, 2013

(30) Foreign Application Priority Data
Jan. 4, 2012 (TW) 101100333

(51) Int. Cl. G06Q 30/06

(52) U.S. Cl. CPC G06Q 30/0605
USPC 705/26.2

(57) ABSTRACT

Network trading systems and methods to be used in an application (App) download use environment are provided. At least one consumer selects required applications by using system operational interfaces (ex. browser pictures, window interface, software operational interfaces), and determines a price expected to buy the selected application. A developer of applications determines to supply the selected application to the at least one consumer with a free promotion and/or a price reduction promotion, according to the number of the consumer expected to buy the application, and/or in addition, the at least one consumer can exchange and use the application according to his use situation.

### BACKGROUND OF THE INVENTION

1. Field of the Invention

The present invention relates generally to network trading systems and methods, and more particularly, to network trading systems and methods to be used in an application (App) download use environment. A developer of applications determines to supply an application to at least one consumer with a free promotion and/or a price reduction promotion, according to the number of the consumer expected to buy the application, and the price that the consumer expected to buy the application. In addition, the application is provided to at least one consumer to use according to the use situation of the consumer.

2. Description of the Related Art

In a conventional network trading model, during the purchase of physical commodities and/or virtual commodities (such as applications), when a purchaser thinks the price of a commodity is too high and/or cannot obtain free use of the commodity, the action that the purchaser only can do is not to purchase the commodity, and that is no way to provide his own opinions and/or a reasonable price which is expected by the purchaser of the commodity to the commodity seller. Also, since the commodity seller cannot receive responses from the purchaser, no two-way communication is existed between the commodity seller and the purchaser, thus facing a bottleneck during commodity selling.

Additionally, for network purchasers, the discounted price of a physical commodity and/or a virtual commodity (such as an application) is determined by the commodity seller, for example, the commodities sold by the Groupon website. In other words, in general, no matter the number of purchaser, the purchasers cannot actively ask the seller for a required discount, and the price is unilaterally determined by the commodity seller.

Further, during a general network trading, since the seller will not supply a commodity to the consumer with a free promotion and/or a price reduction promotion, according to the use situation of the consumer, such as leaving a message for the commodity or pressing a [good] button, the message or response from the consumers is still wanting, and cannot really respond the commodity essence and content.

Consequently, for current network purchasers/consumers, it is expected that a network trading platform can be provided, wherein when the purchaser thinks the price of the commodity is too high and/or there is no way to obtain a free use of the commodity, the purchaser can provide his opinion and/or a reasonable priced expected by the purchaser to the seller via the platform, such that the commodity sellers can obtain responses from the purchaser, thus achieving a two-way communication between the commodity purchaser and sellers. Additionally, the purchasers can actively request the seller for a required discount according to the number of the purchasers, and the seller can supply the commodity to the consumers with a free promotion and/or a price reduction promotion, according to the corresponding use situation, which are conventional problems needed to be solved.

### BRIEF SUMMARY OF THE INVENTION

The objective of the present invention is to provide network trading systems and methods to be used in an application (App) download use environment, in which at least one consumer can select required applications by using system operational interfaces (ex. browser pictures, window interface, software operational interfaces), and determines a price expected to buy the selected application.

Another objective of the present invention is to provide network trading systems and methods to be used in an application (App) download use environment, in which a developer of applications determines to supply the application to the at least one consumer with a free promotion and/or a price reduction promotion, according to the number of the consumer expected to buy the application.

Another objective of the present invention is to provide network trading systems and methods to be used in an application (App) download use environment, in which, at least one consumer can exchange and use the application according to his use situation.

According to above objectives, the present invention provides a network trading system, wherein the network trading system comprises a trading processing module and an application database.

The trading processing module receives a selection requirement of applications from a network consumer side, in which the selection requirement of applications is a request of a selection for a required application via system operational interfaces (ex. browser pictures, window interface, software operational interfaces) from at least one consumer, and comprises information including a purchase price for the application expected to be bought, wherein the purchase price is determined by the at least one consumer. After the selection requirement of applications from at least one network purchaser/consumer side is received, the trading processing module processes and analyzes the selection requirement of applications, thus to obtain the number of the consumers who expected to buy the application, and the information including a purchase price for the application, wherein the purchase price is determined by the consumers. A developer of applications determines to supply the application in the application database to the at least one consumer with a free promotion and/or a price reduction promotion, according to the number of the consumers expected to buy the application and the purchase price for the application, which are processed and analyzed by the trading processing module.

Additionally, the trading processing module can receive the use situation of system operational interfaces (ex. browser pictures, window interface, software operational interfaces) of the at least one consumer on the network consumer side. The trading processing module can supply the application in the application database to the at least one consumer with a free promotion and/or a price reduction promotion, according to the use situation of system operational interfaces (ex. browser pictures, window interface, software operational interfaces) of the at least one consumer.

The application database stores applications, which can be provided to at least one consumer to use.

In a network trading method using the network trading system of the present invention, the trading processing module receives a selection requirement of applications from a network consumer side, in which the selection requirement of applications is a request of a selection for a required application via system operational interfaces (ex. browser pictures, window interface, software operational interfaces) from at least one consumer, and comprises information including a purchase price for the application expected to be bought, wherein the purchase price is determined by the at least one consumer.

Then, after the selection requirement of applications from at least one consumer on the network consumer side is received, the trading processing module processes and analyzes the selection requirement of applications of the at least one consumer, thus to obtain the number of the consumers who expected to buy the application, and the information including the purchase price for the application, wherein the purchase price is determined by the consumers.

Thereafter, a developer of applications determines to supply the application in the application database to the at least one consumer with a free promotion and/or a price reduction promotion, according to the number of the consumers expected to buy the application and the purchase price for the application, which are processed and analyzed by the trading processing module.

In addition, the trading processing module can receive the use situation of system operational interfaces (ex. browser pictures, window interface, software operational interfaces) of the at least one consumer on the network consumer side, and supply the application in the application database to the at least one consumer with a free promotion and/or a price reduction promotion, according to the use situation of system operational interfaces (ex. browser pictures, window interface, software operational interfaces) of the at least one consumer.

Network trading methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a system schematic diagram illustrating the system architecture and operations of the network trading system of the present invention;

FIG. 2 is a flowchart of procedure steps of a network trading method for the network trading system of the present invention;

FIG. 3 is a schematic diagram illustrating an embodiment and operations of the network trading system of the present invention;

FIG. 4 is a flowchart of procedure steps of a network purchasing and trading method using the network trading system in FIG. 3;

FIG. 5 is a schematic diagram illustrating another embodiment and operations of the network trading system of the present invention; and

FIG. 6 is a flowchart of procedure steps of a network purchasing and trading method using the network trading system in FIG. 5.

### DETAILED DESCRIPTION OF THE INVENTION

Network trading systems and methods are provided.

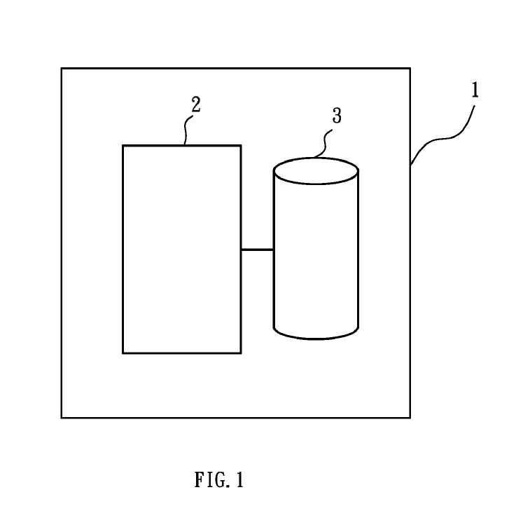

FIG. 1 is a system schematic diagram illustrating the system architecture and operations of the network trading system of the present invention. As shown in FIG. 1, the network trading system 1 comprises a trading processing module 2, and an application database 3.

The trading processing module 2 receives a selection requirement of applications (not shown in figure) from a network consumer side (not shown in figure), in which the selection requirement of applications is a request (not shown in figure) of a selection for a required application via system operational interfaces (ex. browser pictures, window interface, software operational interfaces) (not shown in figure) from at least one consumer (not shown in figure), and comprises information including a purchase price (not shown in figure) for the application expected to be bought, wherein the purchase price is determined by the at least one consumer. After the selection requirement of applications from the network consumer side is received, the trading processing module 2 processes and analyzes the selection requirement of applications, thus to obtain the number of the consumers who expected to buy the application, and the information including a purchase price for the application, wherein the purchase price is determined by the consumers. A developer of applications (not shown in figure) determines to supply the application in the application database 3 to the at least one consumer with a free promotion and/or a price reduction promotion, according to the number of the consumers expected to buy the application and the purchase price for the application, which are processed and analyzed by the trading processing module 2.

Additionally, the trading processing module 2 can receive the use situation of system operational interfaces (ex. browser pictures, window interface, software operational interfaces) of the at least one consumer on the network consumer side. The trading processing module 2 can supply the application in the application database 3 to the at least one consumer with a free promotion and/or a price reduction promotion, according to the use situation of system operational interfaces (ex. browser pictures, window interface, software operational interfaces) of the at least one consumer.

The application database 3 stores applications, which can be provided to at least one consumer to use.

Here, the applications can be applications comply with the Apple platform, and the developer is the provider of applications of the Apple platform. And/or, the applications can be applications comply with the Android platform, and the developer is the provider of applications of the Android platform. It is noted that, the type and developer corresponding to the applications can be various, and may be different according to different practical implementations.

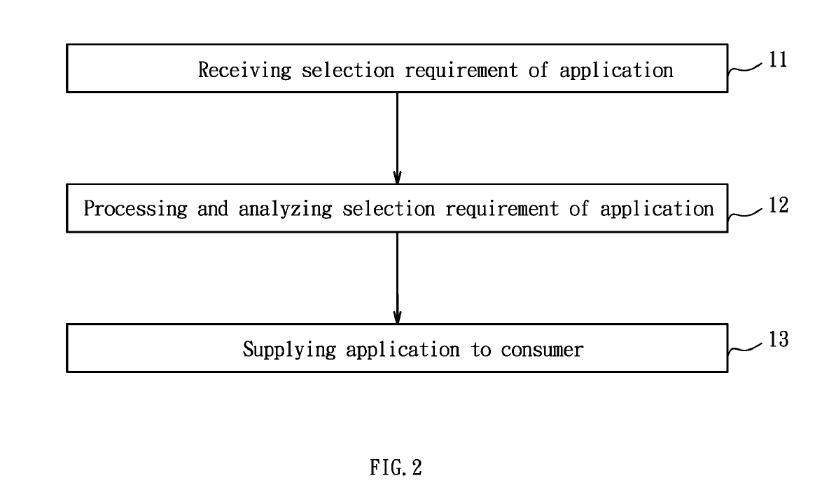

FIG. 2 is a flowchart of procedure steps of a network trading method for the network trading system of the present invention. As shown in FIG. 2, at first, in step 11, the trading processing module 2 receives a selection requirement of applications from a network consumer side, wherein at least one consumer can select a required application, and determine a price expected to buy the application via system operational interfaces (ex. browser pictures, window interface, software operational interfaces), and the selection requirement of applications is a request of a selection for a required application via system operational interfaces (ex. browser pictures, window interface, software operational interfaces) from at least one consumer, and comprises information including a purchase price for the application expected to be bought, wherein the purchase price is determined by the at least one consumer. Then, the procedure goes to step 12.

In step 12, after the selection requirement of applications from at least one consumer on the network consumer side is received, the trading processing module processes and analyzes the selection requirement of applications of the at least one consumer, thus to obtain the number of the consumers who expected to buy the application, and the information including the purchase price for the application, wherein the purchase price is determined by the consumers, and the procedure goes to step 13.

In step 13, a developer of applications determines to supply the application in the application database 3 to the at least one consumer with a free promotion and/or a price reduction promotion, according to the number of the consumers expected to buy the application and the purchase price for the application, which are processed and analyzed by the trading processing module 2.

Additionally, the trading processing module 2 can receive the use situation of system operational interfaces (ex. browser pictures, window interface, software operational interfaces) of the at least one consumer on the network consumer side. The trading processing module 2 can supply the application in the application database 3 to the at least one consumer with a free promotion and/or a price reduction promotion, according to the use situation of system operational interfaces (ex. browser pictures, window interface, software operational interfaces) of the at least one consumer.

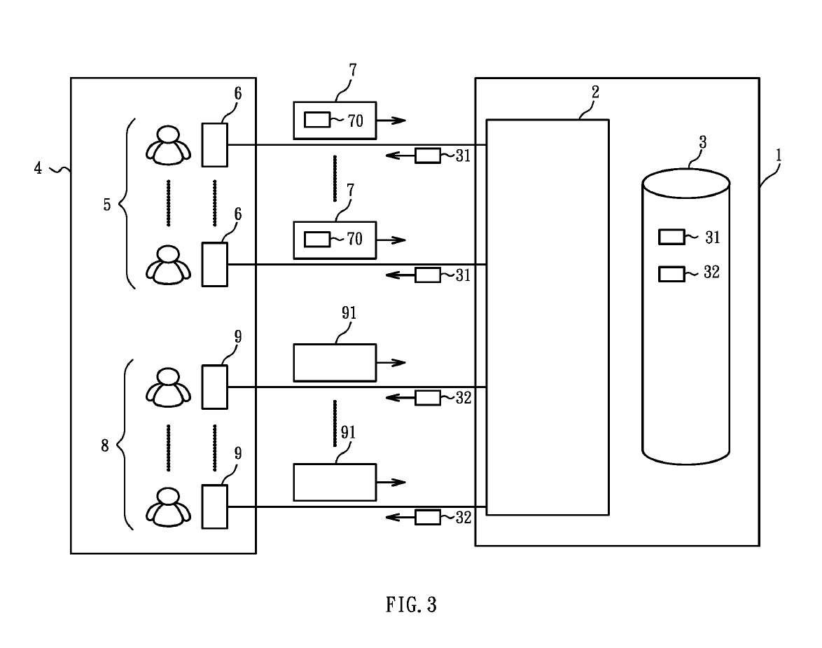

FIG. 3 is a schematic diagram illustrating an embodiment and operations of the network trading system of the present invention. As shown in FIG. 3, the network trading system 1 comprises a trading processing module 2, and an application database 3. Here, the application database 3 stores applications, which can be provided to at least one consumer to use. All users (consumers) of the AppStore can buy an application with the same price. However, a specific number, such as ten of the consumers who expected the price will first receive a notification with the message. Here, the applications can be applications comply with the Apple platform, and the developer is the provider of applications of the Apple platform. And/or, the applications can be applications comply with the Android platform, and the developer is the provider of applications of the Android platform. It is noted that, the type and developer corresponding to the applications can be various, and may be different according to different practical implementations.

The trading processing module 2 receives a selection requirement of applications 7 from a network consumer side 4, in which the selection requirement of applications 7 is a request of a selection for a required application 31 via system operational interfaces 6 (ex. browser pictures, window interface, software operational interfaces) (not shown in figure) from ten consumers 5, and comprises information 70 including a purchase price for the application 31 expected to be bought, wherein the purchase price is determined by the ten consumers.

After ten selection requirements of applications 7 from the network consumer side 4 is received, the trading processing module 2 processes and analyzes the ten selection requirements of applications 7, thus to obtain the number (ten) of the consumers who expected to buy the application 31, and the information 70 including a purchase price for the application 31, wherein the purchase price is determined by the ten consumers. A developer of the application 31 (not shown in figure) determines to supply the application 31 in the application database 3 to the ten consumers with a price reduction promotion, such as 30% off of the original price, according to the number of the consumers expected to buy the application 31 and the purchase price for the application 31, which are processed and analyzed by the trading processing module 2. It is noted that, not only the ten consumers, but also other users (consumers) of the AppStore can buy the application 31 with the mentioned purchase price. In this case, the ten consumers proposed a price and expected to buy the application will first receive the notification of the message.

Additionally, the trading processing module 2 can receive the use situation 91 of system operational interfaces 9 (ex. browser pictures, window interface, software operational interfaces) of the at least one consumer 8 on the network consumer side 4. The trading processing module 2 can supply the application 32 in the application database 3 to the at least one consumer 8 with a free promotion, according to the use situation 91 of system operational interfaces 9 (ex. browser pictures, window interface, software operational interfaces) of the at least one consumer 8.

The application database 3 stores applications 31 and 32, which can be provided to at least one consumer 5 and 8 to use.

In the embodiment, the application 31 is provided to ten consumers with 30% off of the original purchase price. However, in some embodiments, when the number of consumers is greater than a specific number, such as 500, the application can be supply to the consumers with a free promotion, and related operations and details are similar to the above disclosed embodiment, and therefore are omitted here.

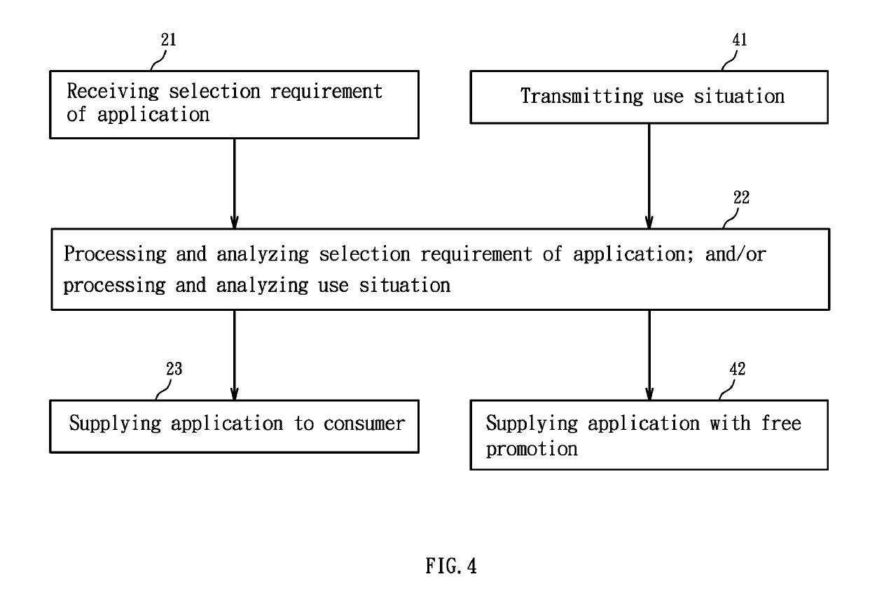

FIG. 4 is a flowchart of procedure steps of a network purchasing and trading method using the network trading system in FIG. 3. As shown in FIG. 4, in step 21, The trading processing module 2 receives a selection requirement of applications 7 from a network consumer side 4, in which the selection requirement of applications 7 is a request of a selection for a required application 31 via system operational interfaces 6 (ex. browser pictures, window interface, software operational interfaces) from ten consumers 5, and comprises information 70 including a purchase price for the application 31 expected to be bought, wherein the purchase price is determined by the ten consumers, and the procedure goes to step 22.

In step 41, the network consumer side 4 transmits the use situation 91 of system operational interfaces 9 (ex. browser pictures, window interface, software operational interfaces) of the at least one consumer 8 to the trading processing module 2, and the procedure goes to step 22.

In step 22, after ten selection requirements of applications 7 from the network consumer side 4 is received, the trading processing module 2 processes and analyzes the ten selection requirements of applications 7, thus to obtain the number (ten) of the consumers who expected to buy the application 31, and the information 70 including a purchase price for the application 31, wherein the purchase price is determined by the ten consumers, and the procedure goes to step 23. And/or, the trading processing module 2 receives the use situation 91 of system operational interfaces 9 (ex. browser pictures, window interface, software operational interfaces) of the at least one consumer 8 on the network consumer side 4, and processes and analyzes the received use situation 91, and the procedure goes to step 42.

In step 23, a developer of the application 31 (not shown in figure) determines to supply the application 31 in the application database 3 to the ten consumers with a price reduction promotion, such as 30% off of the original price, according to the number of the consumers expected to buy the application 31 and the purchase price for the application 31, which are processed and analyzed by the trading processing module 2.

In step S42, the trading processing module 2 supplies the application 32 in the application database 3 to the at least one consumer 8 with a free promotion.

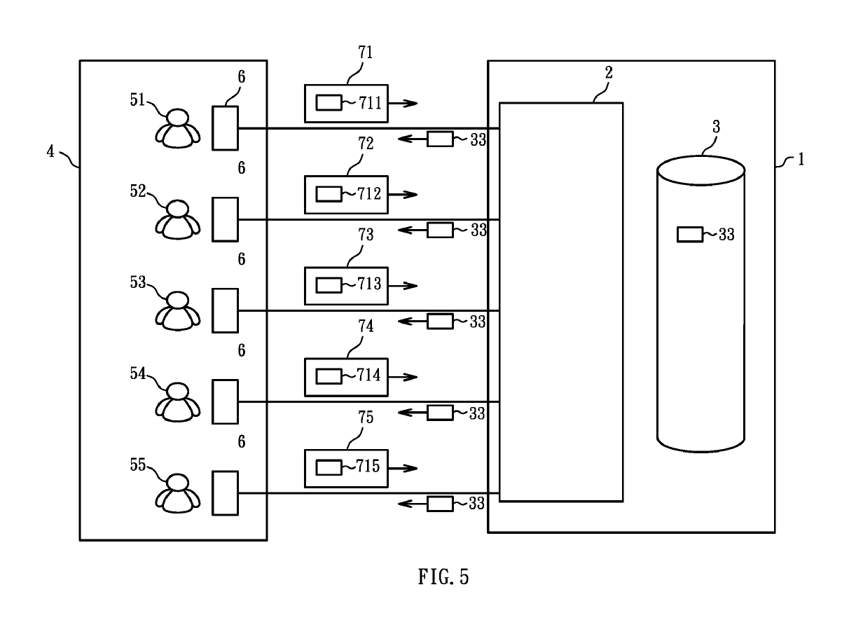

FIG. 5 is a schematic diagram illustrating another embodiment and operations of the network trading system of the present invention.

As shown in FIG. 5, the network trading system 1 comprises a trading processing module 2, and an application database 3. Here, the number of consumers is 5.

The trading processing module 2 receives selection requirements of applications 71, 72, 73, 74 and 75 from a network consumer side 4, in which the selection requirements of applications 71, 72, 73, 74 and 75 are respective requests of a selection for a required application 33 via system operational interfaces 6 (ex. browser pictures, window interface, software operational interfaces) from five consumers 51, 52, 53, 54 and 55, and comprises information 711, 712, 713, 714 and 715 including a purchase price for the application 33 expected to be bought, wherein the purchase price is respectively determined by the five consumers. For example, the information 711 of the purchase price for the application 33 of the consumer 51 is NT 100 dollars, the information 712 of the purchase price for the application 33 of the consumer 52 is NT 110 dollars, the information 713 of the purchase price for the application 33 of the consumer 53 is NT 120 dollars, the information 714 of the purchase price for the application 33 of the consumer 54 is NT 110 dollars, and the information 715 of the purchase price for the application 33 of the consumer 55 is NT 110 dollars.

After five selection requirements of applications 71, 72, 73, 74 and 75 from the network purchaser/consumer side 4 are received, the trading processing module 2 processes and analyzes the five selection requirements of applications 71, 72, 73, 74 and 75, thus to obtain the number of the consumers who expected to buy the application 33, and the respective information 711, 712, 713, 714 and 715 including a purchase price for the application 33, wherein the purchase price is respectively determined by the five consumers. A developer of the application 33 (not shown in figure) determines to respectively supply the application 33 in the application database 3 to the five consumers 51, 52, 53, 54 and 55 with a price reduction promotion, such as a 10% off of an average price (NT 110 dollars (100+120+110+110+110)/5=110)), that is NT 99 dollars (110×0.9=99), according to the number of the consumers expected to buy the application 33 and the respective purchase price for the application 33 (ex., NT 100 dollars, 110 dollars, 120 dollars, 110 dollars and 110 dollars), which are processed and analyzed by the trading processing module 2.

The application database 3 stores applications 33, which can be provided to at least one consumer 51, 52, 53, 54 and 55 to use.

In the embodiment, the price reduction promotion can be performed by a discount of an average price as a purchase price. However, the above performance is only example of the embodiment, and the present invention is not limited thereto. In some embodiments, another specific price can be determined by the developer according to his will. In some embodiments, the price can be determined according to the purchase prices determined by the respective consumers. Further, the discount for the application 33 is not limited to the specific five consumers, and all users (consumers) can buy the application 33 with the same discount. In this case, the five consumers proposed a price and expected to buy the application will real-time receive the related notification.

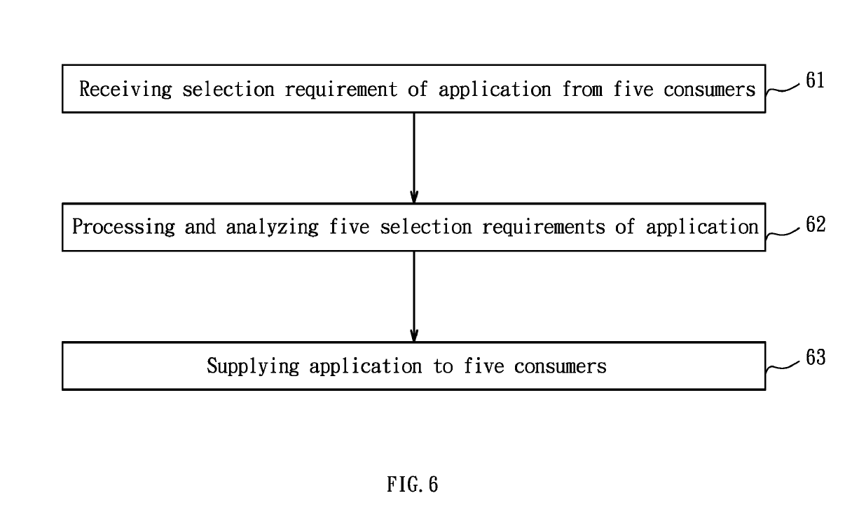

FIG. 6 is a flowchart of procedure steps of a network purchasing and trading method using the network trading system in FIG. 5. As shown in FIG. 6, in step 61, The trading processing module 2 receives selection requirements of applications 71, 72, 73, 74 and 75 from a network purchaser/consumer side 4, in which the selection requirements of applications 71, 72, 73, 74 and 75 are respective requests of a selection for a required application 33 via system operational interfaces 6 (ex. browser pictures, window interface, software operational interfaces) from five consumers 51, 52, 53, 54 and 55, and comprises information 711, 712, 713, 714 and 715 including a purchase price for the application 33 expected to be bought, wherein the purchase price is respectively determined by the five consumers. For example, the information 711 of the purchase price for the application 33 of the consumer 51 is NT 100 dollars, the information 712 of the purchase price for the application 33 of the consumer 52 is NT 110 dollars, the information 713 of the purchase price for the application 33 of the consumer 53 is NT 120 dollars, the information 714 of the purchase price for the application 33 of the consumer 54 is NT 110 dollars, and the information 715 of the purchase price for the application 33 of the consumer 55 is NT 110 dollars. The procedure goes to step 62.

In step 62, after five selection requirements of applications 71, 72, 73, 74 and 75 from the network purchaser/consumer side 4 are received, the trading processing module 2 processes and analyzes the five selection requirements of applications 71, 72, 73, 74 and 75, thus to obtain the number of the consumers who expected to buy the application 33, and the respective information 711, 712, 713, 714 and 715 including a purchase price for the application 33, wherein the purchase price is respectively determined by the five consumers. The procedure goes to step 63.

In step 63, a developer of the application 33 (not shown in figure) determines to respectively supply the application 33 in the application database 3 to the five consumers 51, 52, 53, 54 and 55 with a price reduction promotion, such as a 10% off of an average price (NT 110 dollars (100+120+110+110+110)/5=110)), that is NT 99 dollars (110×0.9=99), according to the number of the consumers expected to buy the application 33 and the respective purchase price for the application 33 (ex., NT 100 dollars, 110 dollars, 120 dollars, 110 dollars and 110 dollars), which are processed and analyzed by the trading processing module 2.

Therefore, the network trading systems and methods of the present invention can be used in an application download use environment, in which at least one consumer selects required applications by using system operational interfaces (ex. browser pictures, window interface, software operational interfaces), and determines a price expected to buy the selected application. That is, the consumer can show an expected price for purchasing a specific application. A developer of applications determines to supply the selected application to the at least one consumer with a free promotion and/or a price reduction promotion, according to the number of the consumer expected to buy the application, and/or in addition, the at least one consumer can exchange and use the application according to his use situation. The network trading systems and methods of the present invention have following advantages:

1. At least one consumer can select required applications by using system operational interfaces (ex. browser pictures, window interface, software operational interfaces), and determine a price expected to buy the selected application.

2. A developer of applications can determine to supply the selected application to the at least one consumer with a free promotion and/or a price reduction promotion, according to the number of the consumer expected to buy the application.

3. At least one consumer can exchange and use the application according to his use situation.

Network trading methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. When implemented on a general-purpose processor, the program code combines with the processor to provide a unique apparatus that operates analogously to the application of specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A network trading method for use in an application download use environment, comprising:
receiving a selection requirement of an application from at least one consumer on a consumer side;
processing and analyzing the selection requirement of the application of the at least one consumer, thus to obtain the number of the consumers who expected to buy the application, and the information including the purchase price for the application, wherein the purchase price is determined by the consumers; and
supplying the application to the at least one consumer with a free promotion and/or a price reduction promotion.

2. The method of claim 1, further comprising:
receiving the use situation of system operational interfaces of the at least one consumer on the consumer side; and
supplying the application to the at least one consumer with a free promotion and/or a price reduction promotion, according to the use situation of system operational interfaces of the at least one consumer,
wherein the system operational interfaces comprises browser pictures, window interface, or software operational interfaces.

3. The method of claim 1, wherein the application complies with the Apple platform or the Android platform.

4. A network trading method for use in an application download use environment, comprising:
receiving a selection requirement of an application from a consumer side, in which the selection requirement of the application is a request of a selection for a required application via system operational interfaces from at least one consumer, and comprises information including a purchase price for the application expected to be bought, wherein the purchase price is determined by the at least one consumer;
processing and analyzing the selection requirement of the application, thus to obtain the number of the consumers who expected to buy the application, and the information including the purchase price for the application, wherein the purchase price is determined by the consumers; and
supplying the application to the at least one consumer with a free promotion and/or a price reduction promotion, according to the number of the consumers who expected to buy the application, and the information including the purchase price for the application,
wherein the system operational interfaces comprises browser pictures, window interface, or software operational interfaces.

5. The method of claim 4, further comprising:
receiving the use situation of the system operational interfaces of the at least one consumer on the consumer side; and
supplying the application to the at least one consumer with a free promotion and/or a price reduction promotion, according to the use situation of system operational interfaces of the at least one consumer,
wherein the system operational interfaces comprises browser pictures, window interface, or software operational interfaces.

6. The method of claim 4, wherein the application complies with the Apple platform or the Android platform.

7. A network trading system for use in an application download use environment, comprising:
a trading processing module receiving a selection requirement of an application from at least one consumer on a consumer side, processing and analyzing the selection requirement of the application of the at least one consumer, thus to obtain the number of the consumers who expected to buy the application, and the information including the purchase price for the application, wherein the purchase price is determined by the consumers, and supplying the application to the at least one consumer with a free promotion and/or a price reduction promotion; and
an application database storing the application, wherein the application complies with the Apple platform or the Android platform.

8. The system of claim 7, wherein the trading processing module further receives the use situation of system operational interfaces of the at least one consumer on the consumer side, and supplies the application to the at least one consumer with a free promotion and/or a price reduction promotion, according to the use situation of system operational interfaces of the at least one consumer, wherein the system operational interfaces comprises browser pictures, window interface, or software operational interfaces.

9. A network trading system for use in an application download use environment, comprising:
a network trading module receiving a selection requirement of an application from a consumer side, in which the selection requirement of the application is a request of a selection for a required application via system operational interfaces from at least one consumer, and comprises information including a purchase price for the application expected to be bought, wherein the purchase price is determined by the at least one consumer, processing and analyzing the selection requirement of the application, thus to obtain the number of the consumers who expected to buy the application, and the information including the purchase price for the application, wherein the purchase price is determined by the consumers, and supplying the application to the at least one consumer with a free promotion and/or a price reduction promotion, according to the number of the consumers who expected to buy the application, and the information including the purchase price for the application; and
an application database storing the application, wherein the application complies with the Apple platform or the Android platform,
wherein the system operational interfaces comprises browser pictures, window interface, or software operational interfaces.

10. The system of claim 9, wherein the trading processing module further receives the use situation of system operational interfaces of the at least one consumer on the consumer side, and supplies the application to the at least one consumer with a free promotion and/or a price reduction promotion, according to the use situation of system operational interfaces of the at least one consumer, wherein the system operational interfaces comprises browser pictures, window interface, or software operational interfaces.
